(19) United States
(12) Patent Application Publication
(10) Pub. No.: US 2016/0320042 A1
(43) Pub. Date: Nov. 3, 2016

(54) MODULARIZED LIGHT-EMITTING DEVICE

(71) Applicant: PROLIGHT OPTO TECHNOLOGY CORPORATION, TAOYUAN COUNTY (TW)

(72) Inventors: CHEN-LUN HSING CHEN, TAOYUAN COUNTY (TW); JUNG-HAO HUNG, TAOYUAN COUNTY (TW); CHUN-CHANG WU, TAOYUAN COUNTY (TW)

(21) Appl. No.: 14/699,163

(22) Filed: Apr. 29, 2015

(51) Int. Cl. F21V 23/06; H05B 33/08; F21V 23/00; H05B 33/06

(52) U.S. Cl. CPC F21V 23/06; H05B 33/06; H05B 33/0842; F21V 23/006

(57) ABSTRACT

The present invention provides a modularized light-emitting device, which comprises a first substrate, a package module, a second substrate, and a plurality of light-emitting modules. The package module packages at least a driving unit and at least a circuit component on the first substrate, which is connected to the second substrate. By the electrical connection between the first and second substrates, the light-emitting module on the second substrate can be driven. Alternatively, the package module is disposed on the first substrate and the plurality of light-emitting modules are disposed on a third substrate. The second substrate is connected electrically with the first and third substrates for driving the light-emitting modules on the third substrate. Accordingly, the light-emitting device is connected to different package modules according to the electrical specification of the light-emitting modules, respectively, and thus improving the flexibility of the light-emitting device.

### FIELD OF THE INVENTION

The present invention relates generally to a light-emitting device, and particularly to a modularized light-emitting device.

### BACKGROUND OF THE INVENTION

Miniaturization and high brightness are required in the design of various types of lamp equipment. High brightness is expected under the condition of not enlarging the overall size. As a consequence, light-emitting diode (LED) lamps are applied extensively. For example, general indoor lamps and streetlamps have migrated to LEDs as their major light-emitting devices.

The package structure of the LED according to the prior art generally comprises a substrate, electrodes formed on the substrate, and an LED chip disposed on the substrate and connected electrically with the electrodes. Normally, the range of the beam angle of an LED chip is around 120°. Thereby, in order to achieve the effect of extending the beam angle of a light-emitting device, multiple LED chips are disposed at certain angles, enabling the LED chips to emit light at different angles and thus forming a greater lighting range.

Nonetheless, driving LEDs by the 110-Volt AC current is challenging. For example, different from incandescent lamps, the light intensity of LEDs is proportional to the current passing through them, instead of the voltage across them. Accordingly, a circuit is required to convert the wire voltage to a fixed current. In addition, the circuit signal might be modulated for driving LEDs to emit light with different intensities via the output signal of a dimmer.

Moreover, LED lamps must include driving circuits for driving LEDs. This structure leads to a larger size of LED lamps. A larger volume occupies the space during delivery as well as increasing the freight costs.

According to the problems as described above, the present invention provides a modularized light-emitting device, which modularizes the driving integrated circuit and the circuit components for shrinking the volume of the driving integrated circuit and is applicable to driving the LEDs in the light-emitting device.

### SUMMARY

An objective of the present invention is to provide a modularized light-emitting device, which packages the driving integrated circuit and the circuit components in a single package structure for reducing the area occupied by the driving integrated circuit and the circuit components.

Another objective of the present invention is to provide a modularized light-emitting device, which further uses the package structure to dispose the function IC for providing the light-emitting device with multi-function control.

The present invention provides a modularized light-emitting device, which comprises a first substrate and a second substrate. A package module and a light-emitting module are disposed on the first and second substrates, respectively. By connecting electrically the first and second substrates, the package module and the light-emitting module are connected electrically. The package module includes at least a driving unit and at least a circuit component. The driving unit drives the light-emitting module via the electrical connection between the first and second substrates. The circuit component modulates the driving voltage and current of at least an LED of the light-emitting module. By using the modularized package, the circuit design of the driving circuit and the light-emitting module is more flexible. Besides, the circuit component matched to the specification of the light-emitting module is disposed in the package module for simplifying the circuit complexity.

### BRIEF DESCRIPTION OF THE DRAWINGS

FIG. 1A shows a schematic diagram of the circuit according to a preferred embodiment of the present invention;

FIG. 1B shows a structural schematic diagram of the package module according to a preferred embodiment of the present invention;

FIG. 1C shows another structural schematic diagram of the package module according to a preferred embodiment of the present invention;

FIG. 1D shows a structural schematic diagram of the light-emitting module according to a preferred embodiment of the present invention;

FIG. 1E shows a structural schematic diagram of the first substrate disposed on the second substrate according to a preferred embodiment of the present invention;

FIG. 2 shows a schematic diagram of the circuit according to another preferred embodiment of the present invention;

FIG. 3A shows a schematic diagram of the circuit according to another preferred embodiment of the present invention;

FIG. 3B shows a schematic diagram of the first substrate connecting electrically with the second substrate according to another preferred embodiment of the present invention;

FIG. 4A shows a schematic diagram of the circuit according to another preferred embodiment of the present invention;

FIG. 4B shows a schematic diagram of the first substrate connecting electrically with the second substrate according to another preferred embodiment of the present invention;

FIG. 5A shows a schematic diagram of the circuit according to another preferred embodiment of the present invention;

FIG. 5B shows a schematic diagram of the first substrate connecting electrically with the second substrate according to another preferred embodiment of the present invention;

FIG. 6A shows a schematic diagram of the circuit according to another preferred embodiment of the present invention; and

FIG. 6B shows a schematic diagram of the package module connecting electrically with the light-emitting module according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

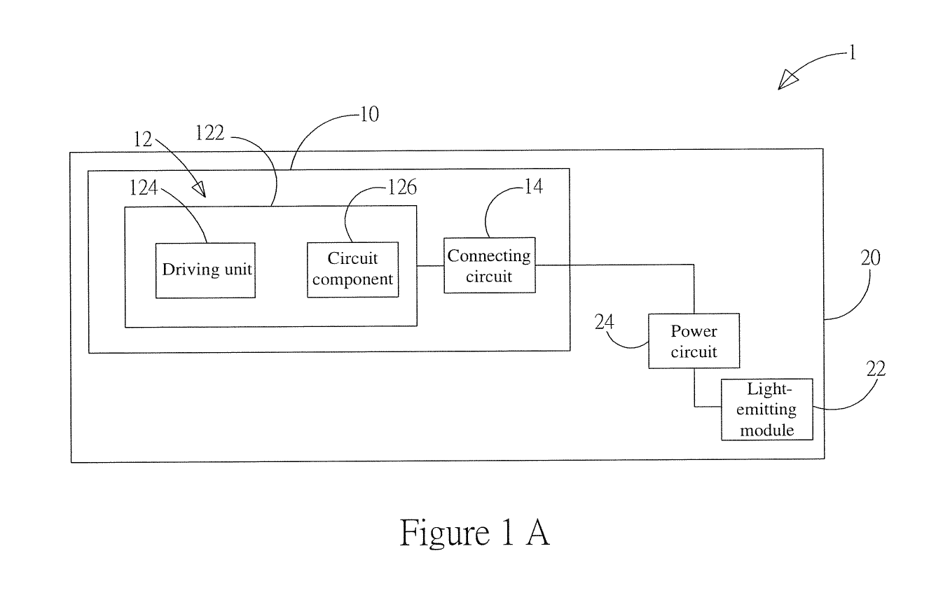

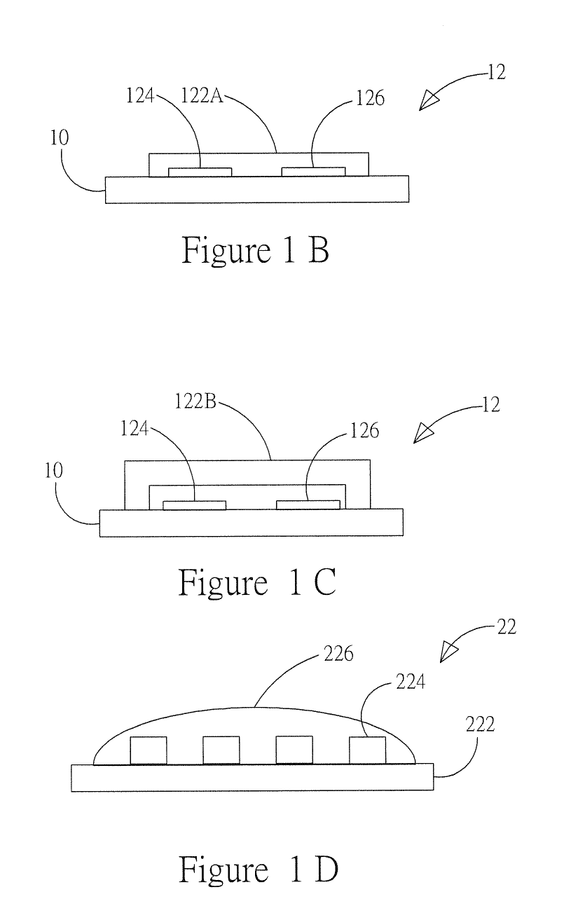

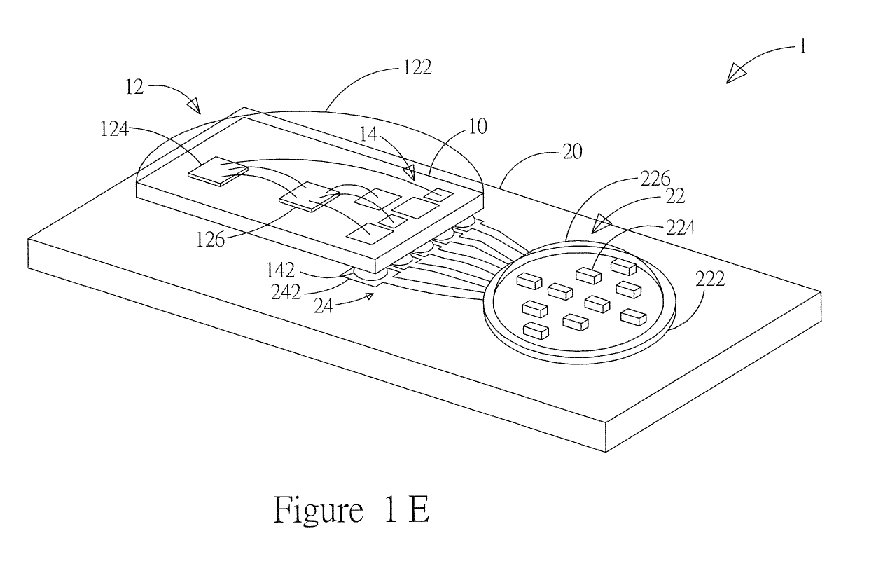

Please refer to FIG. 1A, which shows a schematic diagram of the circuit according to a preferred embodiment of the present invention. As shown in the figure, the modularized light-emitting device 1 according to the present invention comprises a first substrate 10 and a second substrate 20. The first substrate 10 includes a package module 12; the second substrate 20 includes a light-emitting module 22. The package module 12 according to the present embodiment includes a packaging member 122, a driving unit 124, and a circuit component 126. The driving unit 124 is a bare-die integrated circuit. The circuit component 126 can be an active device or a passive device, such as a transistor, a resistor, or a capacitor.

The package module 12 uses the packaging member 122 to package the driving unit 124 and the circuit component 126 onto the first substrate 10. In other words, the driving unit 124 and the circuit component 126 are packaged in the package module 12 by means of the packaging member 122. The pins of the packages module 12 are connected to the external circuit for connecting the circuits on the first substrate 10 to the other devices. The light-emitting module 22 is disposed on the second substrate 20; the first substrate 10 is also disposed on the second substrate 20 for electrical connection. Thereby, the driving unit 124 and the circuit component 126 are connected electrically via the first and second substrates 10, 20 and thus connected electrically to the light-emitting module 22. According to the present embodiment, a connecting circuit 14 is further disposed on the first substrate 10; a power circuit 24 is further disposed on the second substrate 20. By using the electrical connection between the connecting circuit 14 on the first substrate 10 and the power circuit 24 on the second substrate 20, the package module 12 can be connected electrically to the light-emitting module 22.

In general, the material of the first and second substrates 10, 20 is selected from the group consisting of metal, ceramics, and insulating materials. As shown in FIG. 1B, when the packaging member 122 is a seal paste 122A, the package module 12 uses the seal paste 122A to cover and package the driving unit 124 and the circuit component 126. Alternatively, as shown in FIG. 1C, when the packaging member 122 is a cap 122B, the package module 12 combines the cap 122B and the first substrate 10 for covering and packaging the driving unit 124 and the circuit component 126. As shown in FIG. 1D, the light-emitting module 22 includes a module substrate 22 with a plurality of LEDs 224 disposed thereon. The seal paste 226 packages the plurality of LEDs 224. The power circuit 24 distributes the power to each of the LEDs 224 in the light-emitting module 22. As shown in FIG. 1E, the first substrate 10 is disposed on the second substrate 20. The connecting circuit 14 is connected with the power circuit 24. The power circuit 24 according to the present embodiment includes at least a connecting pad 242 for connecting electrically to the first substrate 10. Thereby, the first substrate 10 can connect to the power circuit 24 via the first connecting unit 142 of the connecting circuit 14.

In addition, the supported power of the package module 12 ranges from 3 watts to 100 watts. The package module 12 includes the corresponding number of the driving units 124 and the circuit components 126 according to the supported power. For example, the package module 12 having the supported power of 3 to 10 watts can package one driving unit 124 and one circuit component 126, respectively; the package module 12 having the supported power of 10 to 20 watts can package two driving units 124 and two circuit components 126, respectively.

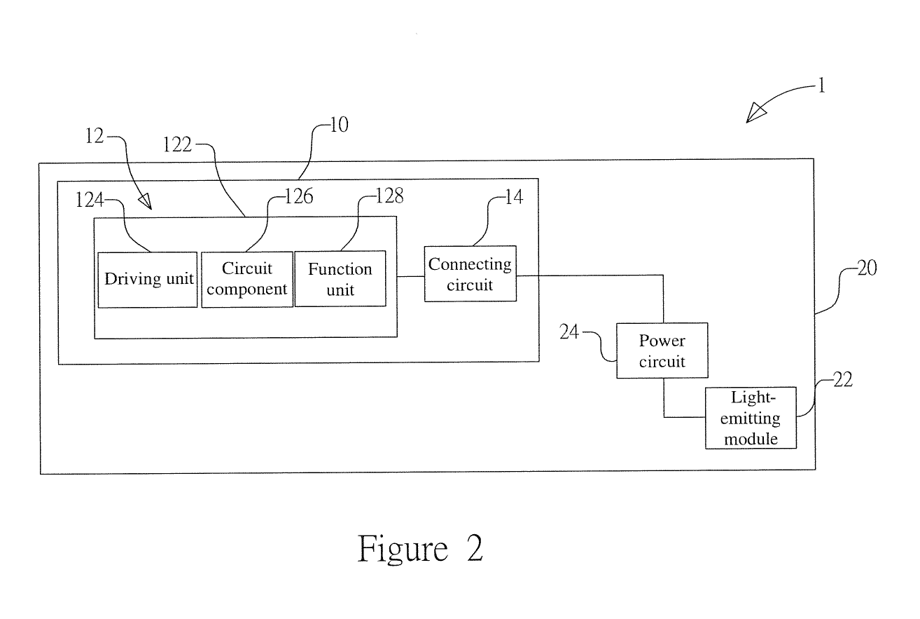

Please refer to FIG. 2, which shows a schematic diagram of the circuit according to another preferred embodiment of the present invention. The difference between FIG. 1A and FIG. 2 is that the package module 12 further includes a function unit 128. As shown in the figure, by further including the function unit 128 in the package module 12, the light-emitting device 1 according to the present invention can provide multi-function control. The function unit 128 is a dimmer integrated circuit, a linear driving integrated circuit, an infrared control integrated circuit, a wireless control integrated circuit, or a photosensitive integrated circuit. Namely, the light-emitting device 1 according to the present invention can use the function unit 128 to provide dimmer control, linear control, infrared detection control, wireless remote control, or photosensitive control for controlling turning on or off of the light-emitting module 22.

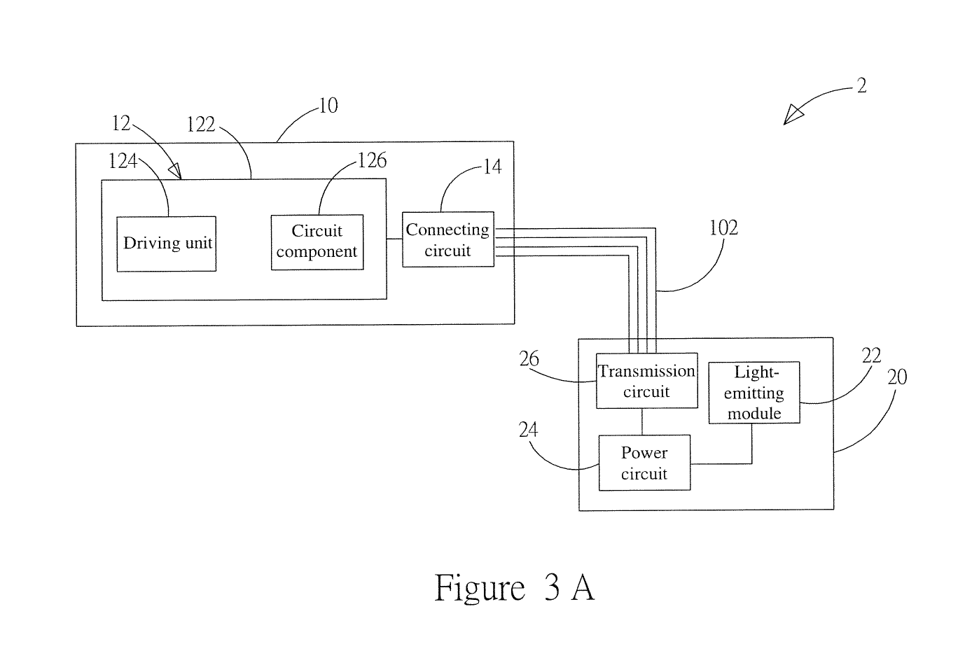

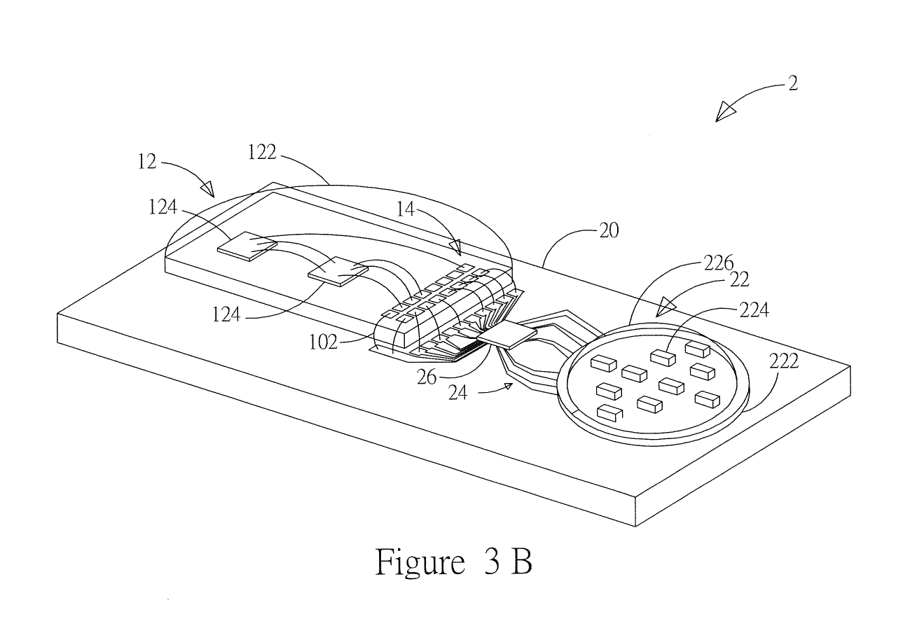

Please refer to FIG. 3A, which shows a schematic diagram of the circuit according to another preferred embodiment of the present invention. As shown in the figure, the light-emitting device 2 according to the present invention can further disposed the first and second substrate 10, 20 separately. Thereby, the first and second substrates 10, 20 are connected electrically through at least a first connecting wire 102. The package module 12 is connected to the power circuit 24 via the connecting circuit 14, the first connecting wire 102, and a transmission circuit 26. Then, the package module 12 can be connected electrically to the light-emitting module 22. Hence, by using the disposition, a single first substrate 10 can be connected to a plurality of second substrates 20 via a plurality of first connecting wires 102 and thus connecting electrically to a plurality of light-emitting modules 22. Because a plurality of light-emitting modules 22 will increase the overall circuit load, more driving units 124 and circuit components 126 should be disposed in the package module 12 for matching the circuit load formed by a plurality of light-emitting modules 22.

As shown in FIG. 3B, the first substrate 10 can be disposed on the second substrate 20 and connected with the power circuit 24 by using the connecting circuit 14 and a plurality of first connecting wires 102. Accordingly, the package module 12 including the function unit 128 can control the light-emitting status of the light-emitting module 22 through the first connecting wire 102.

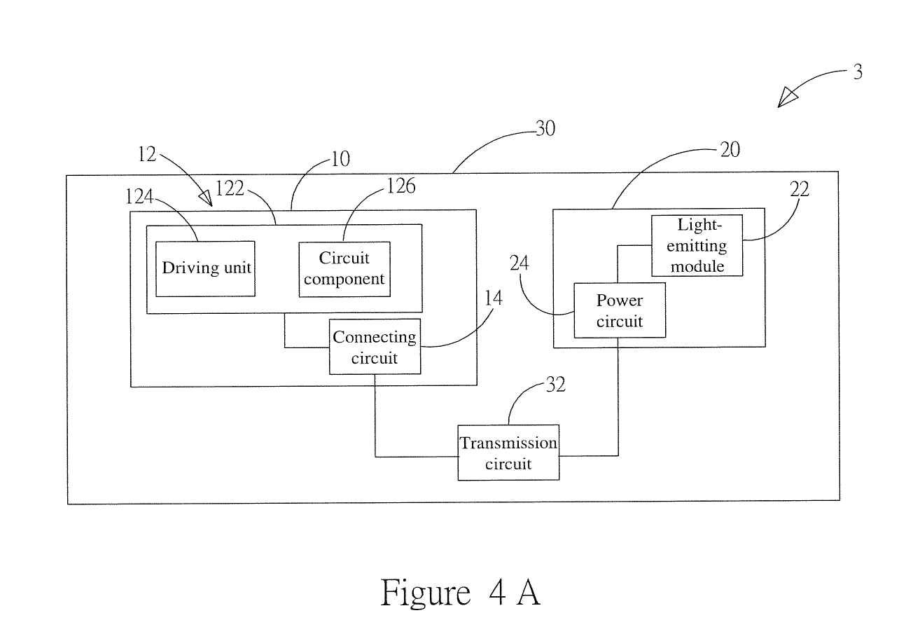

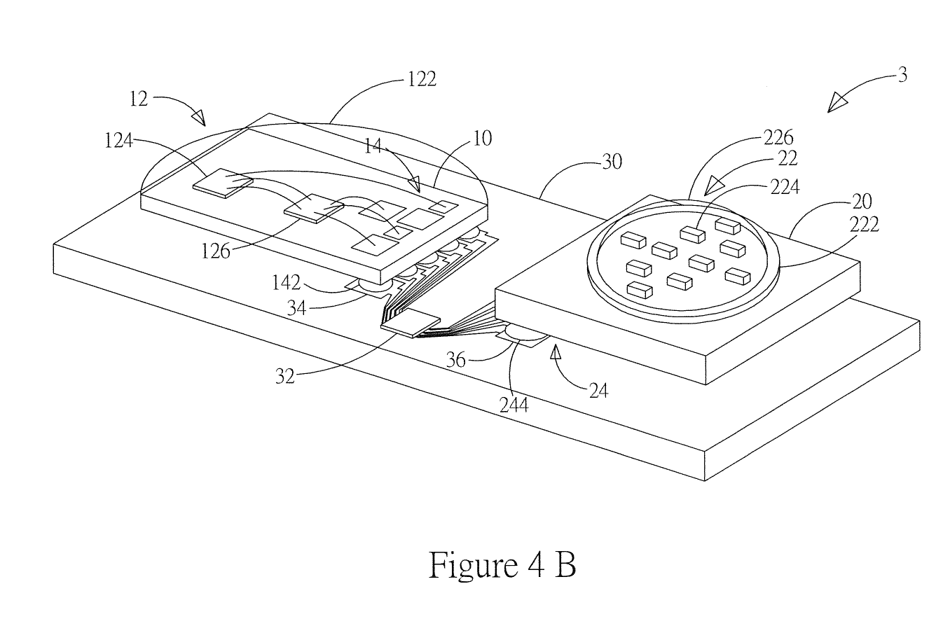

Please refer to FIG. 4A, which shows a schematic diagram of the circuit according to another preferred embodiment of the present invention. As shown in the figure, in the light-emitting device 3 according to the present invention, a third substrate 30 is further disposed between the first and second substrates 10, 20. A transmission circuit 32 is used for connecting electrically the first and second substrates 10, 20 via the third substrate 30. Thereby, the difference between FIG. 3 and FIG. 4 is that the transmission circuit 22 in FIG. 3 is disposed on the second substrate 20, while the transmission circuit 32 in FIG. 4 is disposed on the third substrate 30 and no transmission circuit is disposed on the second substrate 20. Consequently, when the package module 12 on the first substrate 10 is not electrically matched with the light-emitting module 22 on the second substrate 20, only the first substrate 10 is to be disassembled; the other substrates are not altered. The first substrate 10 is replaced until the light-emitting module 22 of the second substrate 20 is matched.

As shown in FIG. 4B, the third substrate 30 includes a first slot 34 and a second slot 36, The first substrate 10 is connected electrically to the transmission circuit 32 of the third substrate 30 via the first connecting unit 142; the second substrate 20 is connected electrically to the transmission circuit 32 of the third substrate 30 via the second connecting unit 244 of the power circuit 24. Thereby, the first and second substrate 10, 20 are connected electrically through the third substrate 30.

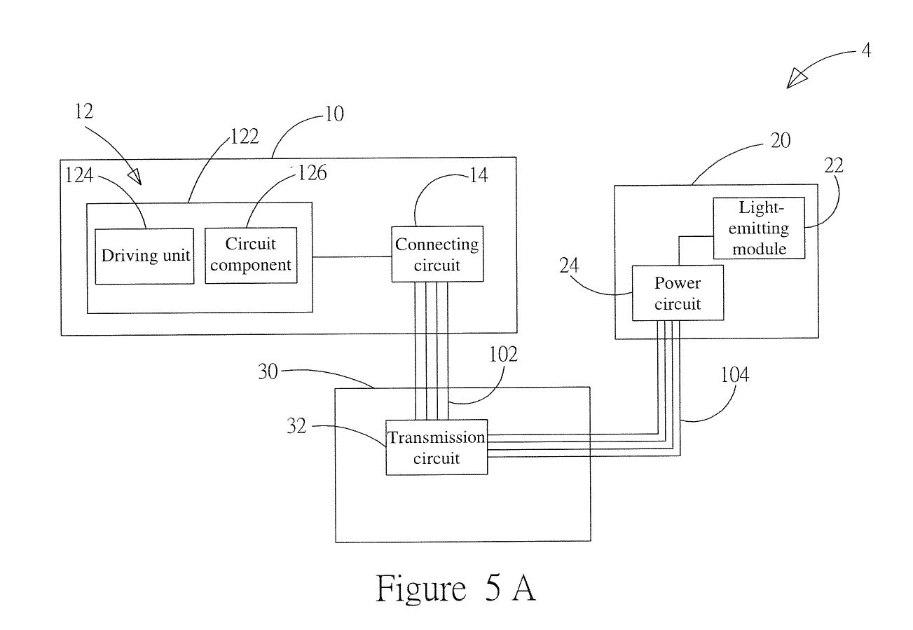

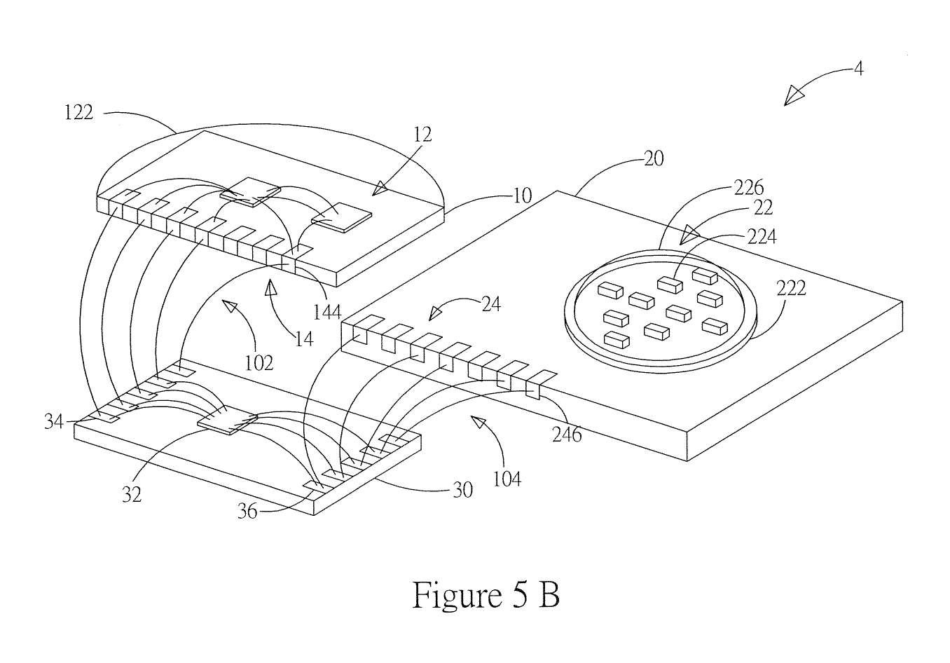

Please refer to FIG. 5A, which shows a schematic diagram of the circuit according to another preferred embodiment of the present invention. As shown in the Figure, the first, second, and third substrates 10, 20, 30 of the light-emitting device 4 according to the present invention are disposed separately. The first and third substrates 10, 30 are connected electrically via the first connecting wire 102; the second and third substrates 20, 30 are connected electrically via the second connecting wire 104. Thus, the package module 12 is connected electrically to the transmission circuit 32 via the connecting circuit 14 and the first connecting wire 102; the light-emitting module 22 is connected electrically to the transmission circuit 32 via the power circuit 24 and the second connecting wire 104. Then the driving unit 124 of the package module 12 can drive the light-emitting module 22 and the circuit component 126 can module the electrical characteristics, such as the driving voltage and current, of the LEDs in the light-emitting module 22. As shown in FIG. 5B, the first, second, and third substrates 10, 20, 30 are disposed separately and the first and second connecting wires 102, 104 are connected to the first and second connecting units 144, 246, respectively. Then the transmission circuit 32 of the third substrate 30 can be connected electrically to the connecting circuit 14 of the first substrate 10 and the power circuit 24 of the second substrate 20 via the first and second connecting pads 34, 36, respectively. Thereby, the driving unit 124 can drive the light-emitting module 22 through the electrical connection as described above and the electrical characteristics of the LEDs 224 can be modulated through the circuit component 126.

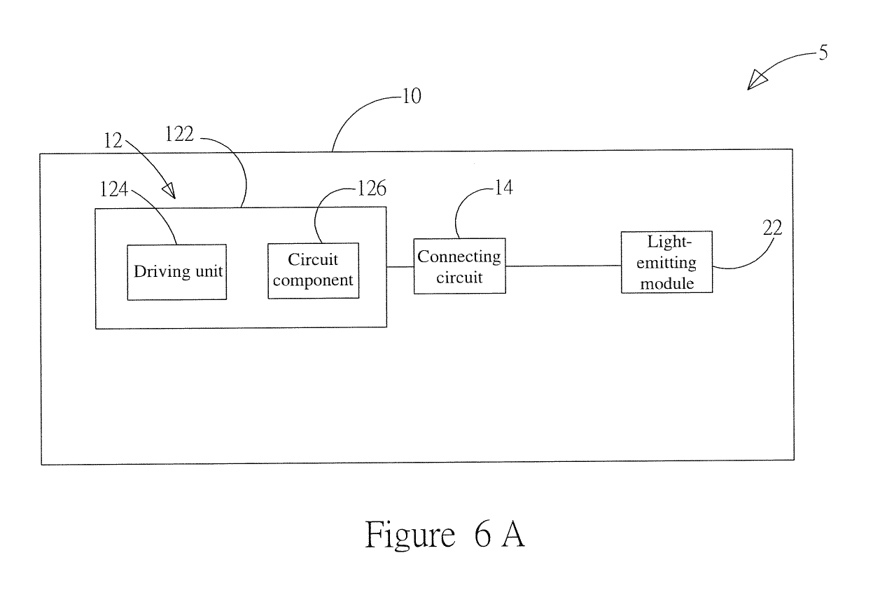

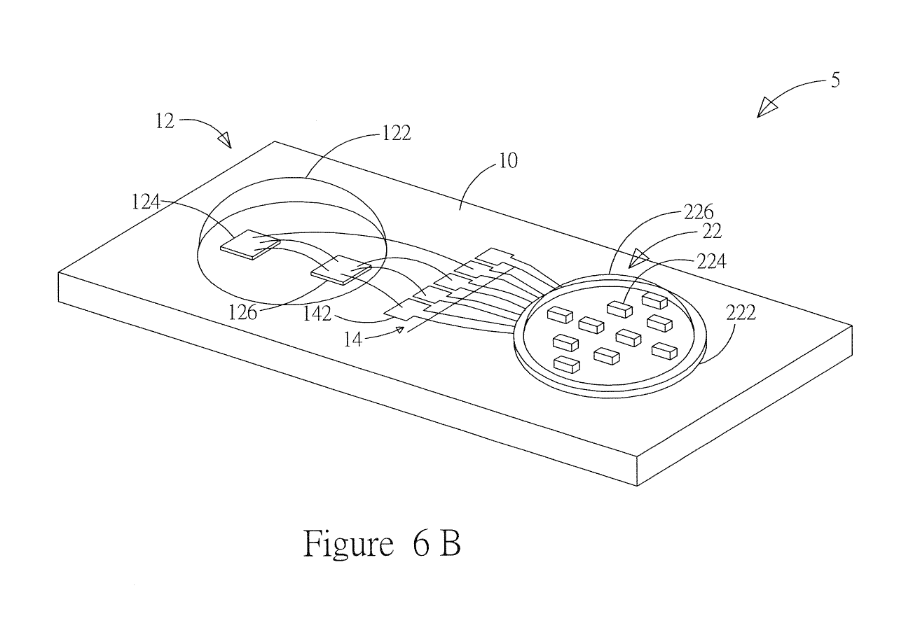

Please refer to FIG. 6A, which shows a schematic diagram of the circuit according to another preferred embodiment of the present invention. The difference between FIG. 5A and FIG. 6A is that the package module 12 and the light-emitting modules in FIG. 5A are located on different substrates, while those in FIG. 6A are on the same substrate, namely, the first substrate 10. Please refer to FIG. 6B as well. The connecting circuit 14 is disposed between the package module 12 and the light-emitting module 22. Hence, the package module 12 can be connected electrically with the light-emitting module 22 via the connecting circuit 14 directly. No extra connecting pad is required for connecting a plurality of connecting wires or connecting units. As a consequence, the weight can be further reduced.

To sum up, the package module in the modularized light-emitting device according to the present invention packages the circuit component and the driving unit together for providing package modules with various electrical characteristics and thus matching light-emitting modules with different electrical characteristics.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A modularized light-emitting device, comprising:
a first substrate, including a connecting circuit;
a package module, disposed on said first substrate, comprising a packaging member, at least a driving unit, and at least a circuit component, said packaging member covering and packaging said driving unit and said circuit component on said first substrate. and said driving unit and said circuit component electrically connected to said connecting circuit of said first substrate;
a second substrate, including a power circuit electrically connected with said connecting circuit of said first substrate; and
a light-emitting module, disposed on said second substrate, electrically connected to said package module via the electrical connection of said connecting circuit and said power circuit, including at least a light-emitting diode, said driving unit driving said light-emitting module, and said circuit component modulating a driving voltage and a driving current of said light-emitting diode.

2. The modularized light-emitting device of claim 1, wherein said connecting circuit of said first substrate is connected electrically to said power circuit of said second substrate via at least a wire.

3. The modularized light-emitting device of claim 1, wherein said second substrate includes a plurality of connecting pads and said connecting circuit of said first substrate is connected electrically to said plurality of connecting pads.

4. The modularized light-emitting device of claim 1, wherein said package module further comprising:
a function unit, covered and packaged on said first substrate along with said driving unit and said circuit component, being a modulating integrated circuit, a linear driving integrated circuit, an infrared control integrated circuit, a wireless control integrated circuit, or a photosensitive control integrated circuit.

5. The modularized light-emitting device of claim 1, wherein the material of each of said substrates is selected from metal, ceramic, or an insulating material.

6. The modularized light-emitting device of claim 1, wherein said circuit component is a transistor, a diode, a resistor, or a capacitor.

7. The modularized light-emitting device of claim 1, wherein said packaging member is a package paste or a cap.

8. The modularized light-emitting device of claim 1, wherein the supported power of said package module ranges from 3 watts to 100 watts and said package module includes the corresponding number of said driving unit and said circuit component according to the supported power.

9. The modularized light-emitting device of claim 1, further comprising a third substrate, including a transmission circuit connected with said first substrate and said second substrate, and said transmission circuit connected electrically to said package module and said light-emitting module via the electrical connection of said connecting circuit of said first substrate and said power circuit of said second substrate.

10. The modularized light-emitting device of claim 9, wherein said transmission circuit of said third substrate is connected electrically to said connecting circuit of said first substrate and said power circuit of said second substrate via a plurality of wires.

11. The modularized light-emitting device of claim 9, wherein said third substrate includes a plurality of connecting pads; said transmission circuit is connected electrically to said plurality of connecting pads; and said connecting circuit of said first substrate and said power circuit of said second substrate are connected electrically to said plurality of connecting pads via a first connecting unit and a second connecting unit, respectively.

12. The modularized light-emitting device of claim 9, wherein said package module further comprising:
a function unit, covered and packaged on said first substrate along with said driving unit and said circuit component, being a modulating integrated circuit, a linear driving integrated circuit, an infrared control integrated circuit, a wireless control integrated circuit, or a photosensitive control integrated circuit.

13. The modularized light-emitting device of claim 9, wherein the material of each of said substrates is selected from metal, ceramic, or an insulating material.

14. The modularized light-emitting device of claim 9, wherein said circuit component is a transistor, a diode, a resistor, or a capacitor.

15. The modularized light-emitting device of claim 9, wherein said packaging member is a package paste or a cap.

16. The modularized light-emitting device of claim 9, wherein the supported power of said package module ranges from 3 watts to 100 watts and said package module includes the corresponding number of said driving unit and said circuit component according to the supported power.

17. A modularized light-emitting device, comprising:
a substrate, including a connecting circuit;
a package module, disposed on said substrate, comprising a packaging member, at least a driving unit, and at least a circuit component, said packaging member covering and packaging said driving unit and said circuit component on said substrate, and said driving unit and said circuit component connected electrically to said connecting circuit; and
a light-emitting module, disposed on said substrate, connected electrically to said package module via said connecting circuit, including at least a light-emitting diode, said driving unit driving said light-emitting module, and said circuit component modulating a driving voltage and a driving current of said light-emitting diode.

18. The modularized light-emitting device of claim 17, wherein said package module further comprising:
a function unit, covered and packaged on said first substrate along with said driving unit and said circuit component, being a modulating integrated circuit, a linear driving integrated circuit, an infrared control integrated circuit, a wireless control integrated circuit, or a photosensitive control integrated circuit.

19. The modularized light-emitting device of claim 17, wherein the material of each of said substrates is selected from metal, ceramic, or an insulating material.

20. The modularized light-emitting device of claim 17, wherein said circuit component is a transistor, a diode, a resistor, or a capacitor.

21. The modularized light-emitting device of claim 17, wherein said packaging member is a package paste or a cap.

22. The modularized light-emitting device of claim 17, wherein the supported power of said package module ranges from 3 watts to 100 watts and said package module includes the corresponding number of said driving unit and said circuit component according to the supported power.
